(19) United States
(12) Patent Application Publication
(10) Pub. No.: US 2025/0178472 A1
(43) Pub. Date: Jun. 5, 2025

(54) VEHICLE GUIDANCE DEVICE USING CHARGER USAGE RATE

(71) Applicant: GRIDWIZ INC., Gyeonggi-do (KR)

(72) Inventors: KU HWAN KIM, Gyeonggi-do (KR); JUNE WOO RYU, Gyeonggi-do (KR); HYUN WOONG KIM, Gyeonggi-do (KR); HYEON GI LEE, Gyeonggi-do (KR)

(21) Appl. No.: 18/953,393

(22) Filed: Nov. 20, 2024

(30) Foreign Application Priority Data
Nov. 30, 2023 (KR) 10-2023-0170443

(51) Int. Cl. B60L 53/66; B60L 53/62; B60L 53/63

(52) U.S. Cl. CPC B60L 53/665; B60L 53/62; B60L 53/63

(57) ABSTRACT

A vehicle guidance device includes at least one of a group setting part configured to group a plurality of charger populations on a basis of parameters including charger usage rate or a cumulative charging amount, a differential price setting part configured to assign differential charging prices to individual charger groups according to grouping information provided by the group setting part, and an output limit setting part configured to assign differential charger output limits to the individual charger groups according to the grouping information provided by the group setting part, wherein priorities in guidance for electric vehicle charging may be set according to charging price rankings determined by the differential price setting part or output limit rankings determined by the output limit setting part.

### CROSS REFERENCE TO RELATED APPLICATIONS AND CLAIM OF PRIORITY

This application claims the benefit under 35 USC § 119 of Korean Patent Application No. 10-2023-0170443, filed on Nov. 30, 2023, in the Korean Intellectual Property Office, the entire disclosure of which is incorporated herein by reference for all purposes.

### BACKGROUND

### 1. Technical Field

The present disclosure relates to a vehicle guidance device that guides electric vehicles so that the usage rate of chargers is equalized using parameters including a charger usage rate or a cumulative charging amount.

### 2. Description of the Related Art

For electric vehicle (EV) chargers, due to the nature of the installation environment and the frequent use of chargers in parking spots preferred by electric vehicle users, there may be an imbalance in number of uses or number of charging times between multiple chargers. However, due to the nature of the installation of electric vehicle chargers, it is not easy to move the location of the charger once installed.

Even if multiple chargers are installed at one charging station, the number of uses of each charger may vary, which may accelerate the aging of certain chargers or result in some chargers being used significantly less frequently. Moreover, usage imbalance may lead to differences in charger usage rates between adjacent charging stations, resulting in an unbalanced load in the power system. Therefore, in terms of power system stability as well, analysis using charger usage rate is necessary as a way to properly distribute the load.

### SUMMARY

Accordingly, the present disclosure has been made keeping in mind the above problems occurring in the related art, and present disclosure is intended to provide a vehicle guidance device that classifies a plurality of chargers into a plurality of classified charger groups on the basis of parameters including a charger usage rate or a cumulative charging amount so that the usage rates between the chargers or between charging stations is equalized. In addition, the vehicle guidance device sets differential prices or output limits according to the grouped charger groups, and provides electric vehicle users with information such as differential price settings or output limits in order to guide vehicles to chargers that are less frequently used.

In order to achieve the above objective, according to an aspect of the present disclosure, there is provided a vehicle guidance device including at least one of: a group setting part configured to group a plurality of charger populations on a basis of parameters including charger usage rate or a cumulative charging amount; a differential price setting part configured to assign differential charging prices to individual charger groups according to grouping information provided by the group setting part; and an output limit setting part configured to assign differential charger output limits to the individual charger groups according to the grouping information provided by the group setting part, wherein priorities in guidance for electric vehicle charging may be set according to charging price rankings determined by the differential price setting part or output limit rankings determined by the output limit setting part.

The vehicle guidance device of the present disclosure can classify the lifespan grade of a charger or a charger group by grouping chargers so that the usage rate is equalized using parameters including a charger usage rate or a cumulative charging amount, and can guide vehicles by applying differential prices to charger groups or by setting charger output limits. This, in turn, can lead to life management of the charger or charger group.

As such, the vehicle guidance device of the present disclosure can determine differential prices for each charger, or determine individual charging station or differential charger output by calculating the charger usage rate over a predetermined period of time.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view showing the relationship between chargers or charging stations, a server, and terminals in an environment to which a vehicle guidance device of the present disclosure is applied;

FIG. 2 shows a vehicle guidance method of the present disclosure;

FIGS. 3 to 6 are explanatory views of group setting of the present disclosure; and

FIG. 7 is an explanatory view of charger group movement and charger group centroid movement due to the group setting of the present disclosure.

### DETAILED DESCRIPTION

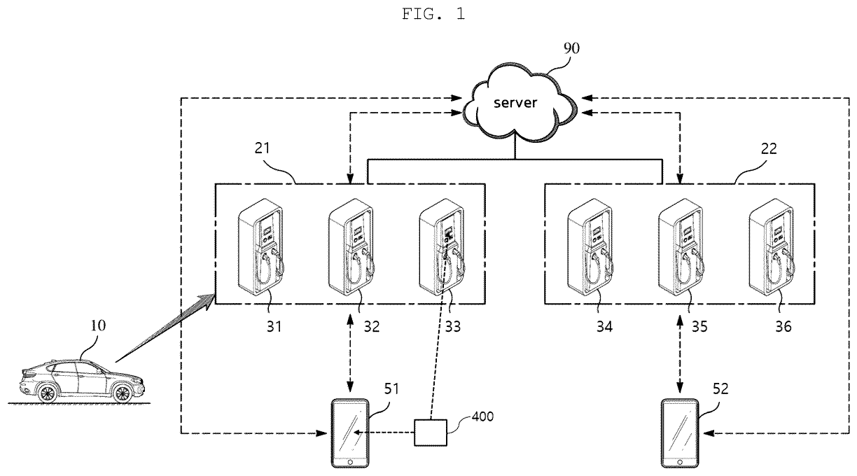

Hereinafter, with reference to FIGS. 1 to 7, a vehicle guidance device and a vehicle guidance method of the present disclosure will be described.

FIG. 1 illustrates an environment in which the vehicle guidance device and the vehicle guidance method of the present disclosure are applicable. Each electric vehicle charging station 20 may be provided with a plurality of electric vehicle chargers 30. Individual electric vehicle charging stations 20 may belong to the same charger operator or charger service provider, or may belong to different operators or service providers.

For example, a first charging station 21 may be provided with a first charger 31, a second charger 32, and a third charger 33, whereas a second charging station 22 may be provided with a fourth charger 34, a fifth charger 35, and a sixth charger 36. The first charging station 21 and the second charging station 22 may be operated by the same charger operator, and data about the first charging station 21 and the second charging station 22 may be transmitted to a server 90. A user of an electric vehicle 10 may communicate with individual charger 30 or the server 90 through his or her terminal 50 and transmit and receive data. A first terminal 51 may be a terminal of an electric vehicle user wishing to charge at the first charging station 21, and a second terminal 52 may be a terminal of an electric vehicle user wishing to charge at the second charging station 22.

A charger that guides (S300) a vehicle according to a method such as setting (S310) differential prices or setting (S330) output limits on the basis of grouping (S200) of the present disclosure may include the charging stations 21 and 22 managed by the same charger operator, or all chargers 30 installed at the charging stations 21 and 22. The basic unit of a charger group G may be set to a charger, and if the number of operating charging stations 20 is large, the charging station 20 may be set as the basic unit of charger grouping.

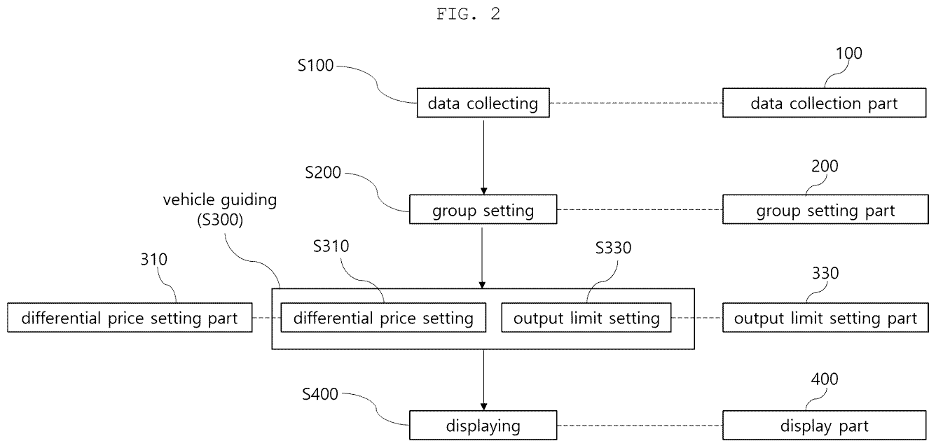

Referring to FIG. 2, the vehicle guidance device of the present disclosure may include at least one of a data collection part 100, a group setting part 200, a differential price setting part 310, an output limit setting part 330, a display part 400, and a controller 500.

The vehicle guidance method of the present disclosure may include at least one of data collecting S100, group setting S200, vehicle guiding S300, and displaying S400.

The group setting part 200 may group a plurality of charger populations on the basis of parameters including charger usage rate or cumulative charging amount. The differential price setting part 310 may differentially assign differential charging prices to individual charger groups according to the grouping information provided by the group setting part 200. The output limit setting part 330 may differentially assign charger output limits to individual charger groups according to the grouping information provided by the group setting part 200. That is, the vehicle guidance device may vary the priorities in guidance for the electric vehicle 10 charging according to the charging price rankings determined by the differential price setting part 310 or the output limit rankings determined by the output limit setting part 330.

In the step of data collecting S100, the data collection part 100 may collect parameter information for use by the group setting part 200 to group the charger populations in the group setting step S200. For example, the grouping parameters may include charger usage rate or cumulative charging amount. Information on the charger usage rate or cumulative charging amount may be stored in a database provided in each charger 30 or in the server 90 whenever charging is performed in each charger 30. Accordingly, the parameter information for grouping the chargers may be transmitted to the group setting part 200 through a charger communication control module of each charger or the server 90.

The charger communication control module provided in the charger may communicate with an electric vehicle (EV) communication control module provided in the electric vehicle and may mutually transmit and receive data.

The electric vehicle communication control module may be an electric vehicle communication controller (EVCC). The EVCC may control communication between a controller inside the vehicle and the charging infrastructure for fast and slow charging of the electric vehicle 10. The EVCC may be a communication control module that can control charging states regarding voltage and current, provide rate information, and perform security authentication functions through communication with charging infrastructure such as the charger 30 when charging the electric vehicle 10.

That is, when a charging cable connected to the charger 30 is connected to the electric vehicle 10, the electric vehicle communication control module may start communication by detecting a PWM signal and sending a signal to the charger communication control module of the charger 30. In this case, the charger communication control module may be a supply equipment communication controller (SECC). Thus, as the electric vehicle 10 and the charger 30 are electrically connected by means of the charging cable, the electric vehicle communication control module and the charger communication control module may exchange signals or information with each other.

In the step of group setting S200, the group setting part 200 may receive data including the parameter information for grouping from the data collection part 100.

The group setting part 200 may group the charger populations on the basis of the parameter information including the charger usage rate or cumulative charging amount. The group setting part 200 may examine the classified electric vehicle charger groups G for each parameter and assign grade levels such as a lifespan grade. In the subsequent vehicle guiding step S300, the priority for vehicle guidance may be determined by setting differential prices or setting output limits according to the grade levels assigned to individual charger groups. That is, the group setting part 200 may select the target charger 30 or charger group G with the highest priority of vehicle guidance.

In the step of vehicle guiding S300, the differential price setting part 310 or the output limit setting part 330 may receive information about the grouping results from the group setting part 200.

There may be several ways to guide electric vehicle users or operators to a specific electric vehicle charger 30, but the most effective and direct method may include differential charging prices and charging output limits.

That is, the vehicle guidance device of the present disclosure may determine differential charging prices for each charging station or charger, or determine differential charger output by calculating the rate of use of the charger 30 over a predetermined period of time.

In the step of displaying S400, the display part 400 may display or provide the target charger 30 or charger group G with the highest or high vehicle guidance priority so that the electric vehicle user can identify the target charger 30 or charger group G with the highest or high vehicle guidance priority. That is, the electric vehicle user can identify differential information by price or output of the charger 30 step by step by means of the display part 400.

Information regarding differential charging prices or differential output limits may be provided to electric vehicle users by means of the display part 400 provided by the charging service provider or charger operator.

As shown in FIG. 1, the display part 400 may be implemented in software on the electric vehicle user's terminal 50 or a charging kiosk through a smartphone app or a web format such as a homepage, or may be implemented in hardware in the electric vehicle charger 30 so that the display part 400 may be visually identified by the electric vehicle 10 user when the electric vehicle 10 approaches the charging station 20 or the charger 30 for charging.

In the former case of the S/W implementation, the occurrence of events such as price comparison information or discount information of other charger operators may also be indicated.

In the latter case of the H/W implementation, the display part 400 may be provided in the charging station 20 or each charger 30 so that the electric vehicle user can identify the differential charging prices or the charger output status, and may be provided in the form of LED color, number marking, level marking, etc.

The controller 500 may control the entire process so that at least one of the data collection part 100, the group setting part 200, the differential price setting part 310, the output limit setting part 330, and the display part 400 included in the vehicle guidance device may perform the vehicle guidance method including at least one of the steps of data collecting S100, group setting S200, vehicle guiding S300, and displaying S400.

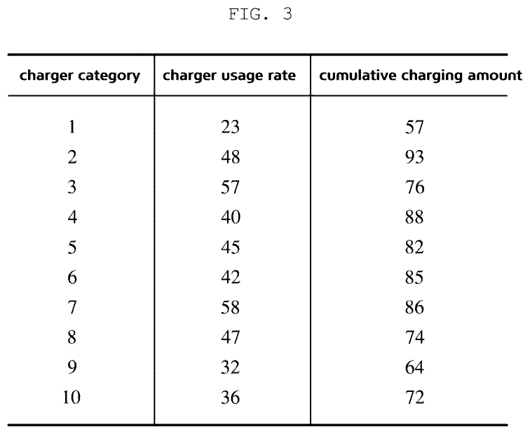

Referring to FIGS. 3 to 7, the step of group setting S200 will be described with a specific example.

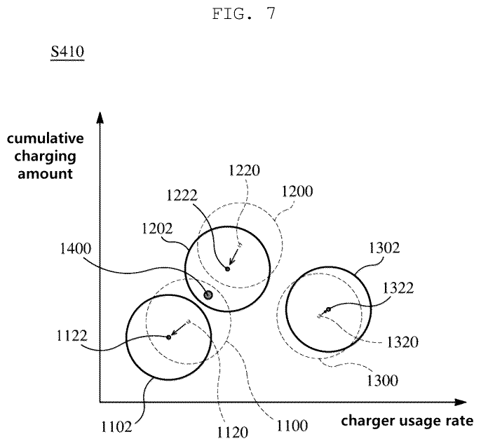

To track and equalize the usage rate of individual chargers, grouping may be done according to parameters related to the charger lifespan. The parameters may include charger usage rate or cumulative charging amount. The type of parameter and the number of parameters may vary or be further expanded, but the step of group setting S200 described in this specification may be similarly expanded and applied. Thus, although the following describes two parameters related to the charger life, which are the charger usage rate and cumulative charging amount, when three or more parameters are selected, the two-dimensional description of FIG. 7 may be extended to three or more dimensions and applied similarly.

In FIG. 3, parameter values for charger usage rate and cumulative charging amount for each charger 30 are given. This is a case where the charger usage rate is selected as the first parameter and the cumulative charging amount is selected as the second parameter.

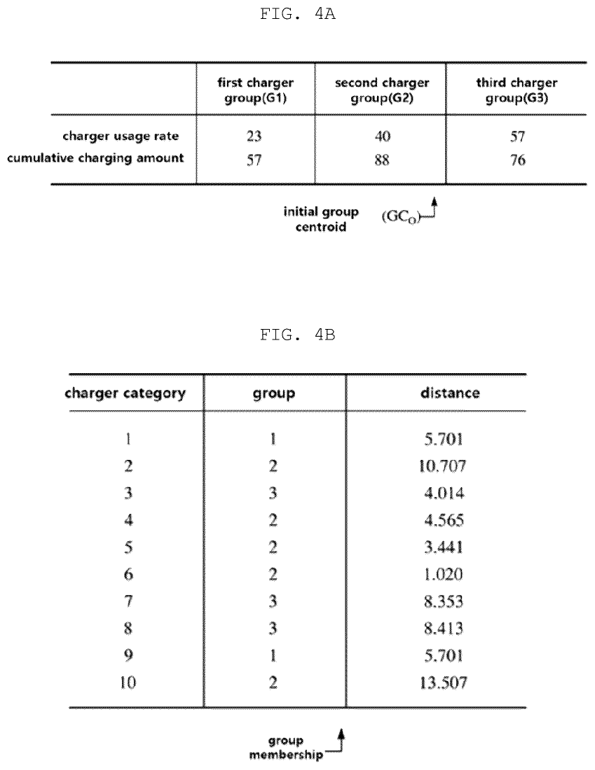

FIG. 4A shows that three values are selected as initial centroids of individual charger groups. Although the number of charger groups is three as an example, when the number of charger groups is two or more, the discussions may be applied similarly. The number of groups may be appropriately determined according to the parameter value distribution in FIG. 3. When calculating the distance between groups to determine the appropriate number of groups, the sum of the variance values of the chargers' parameter values may be used as the basis. To be specific, the appropriate number of groups may be determined by determining the distance between groups on the basis of the degree to which each charger 30 belonging to two groups deviates from the mean, that is, the square of the deviation summed across all chargers.

In FIG. 4B, the total number of chargers 30 is selected as ten, and individual charger 30 may belong to one of a first charger group G1, a second charger group G2, and a third charger group G3 depending on the distance from the three initial group centroids GC0 in FIG. 4A.

At this time, the total number of chargers 30 as a population may be provided encompassing a plurality of charging stations 20. Although, for convenience, the charger 30 is described as the basic unit, when there are many charging stations 20 to be grouped, the charging station 20 may be used as the basic unit. In this case, similar to the first charger group, second charger group, third charger group, etc., a first charging station group, second charging station group, third charging station group, etc. may be applied.

The distance from the initial group centroids GC0 of individual charger 30 may include a Euclidean distance or a squared Euclidean distance. The Euclidean distance may mean the Pythagorean distance between individual charger 30 and the initial group centroids GC0, based on the parameter value (charger usage rate, cumulative charging amount) assigned to individual charger 30. The squared Euclidean distance may mean the square of the Euclidean distance.

As shown in FIG. 4A, each charger 30 may be expressed as (first parameter value, second parameter value). As the initial group centroids GC0, the first charger (first parameter 23, second parameter 57) may be selected for the first charger group G1, the fourth charger (40, 88) may be selected for the second charger group G2, and the third charger (57, 76) may be selected for the third charger group G3. Depending on the distances from the initial group centroids GC0, the first charger group G1 may include the first charger and the ninth charger, the second charger group G2 may include the second charger, the fourth charger, the fifth charger, the sixth charger, and the tenth charger, and the third charger group G3 may include the third charger, the seventh charger, and the eighth charger.

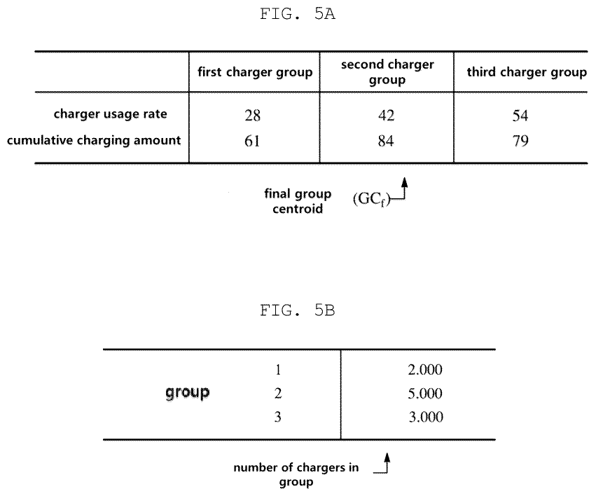

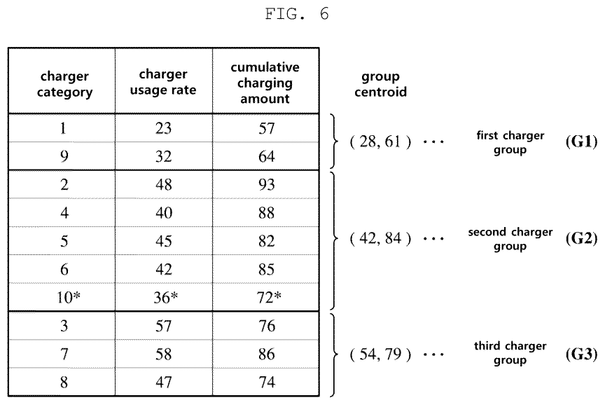

FIG. 5A shows final group centroids GCf, and FIG. 5B shows the number of chargers belonging to each group. The table in FIG. 6 shows the results of the grouping.

Referring to FIGS. 6 and 7, the final group centroids GCf may vary depending on the distribution of chargers 20 belonging to each group. For example, the centroid value of the charger usage rate of the first charger and the ninth charger belonging to the first charger group G1 is 27.5(=(23+32)/2), which is rounded to 28. The centroid value may be expressed as (first parameter value, second parameter value). The centroid value of the first charger group G1 may be (28, 61), and the centroid value of the third charger group G3 may be (54, 79).

From the above results, since the first charger group G1 has a low charger usage rate and cumulative charging amount, the first charger group G1 may not require much replacements or repairs, and may be classified into the upper grade among upper, middle, and lower grades in terms of charger life expectancy. Thus, the first charger group G1 falls into the upper grade level for vehicle guidance, and may be the group to which a charging vehicle will be guided with the highest priority. Such information may be provided to electric vehicle users by means of the display part 400.

The second charger group G2 may be the group with the highest cumulative charging amount, and the third charger group G3 may be the group with the highest charger usage rate. The classification grade level may vary depending on which parameter is used to classify a group as the upper, middle, or lower grade in terms of charger life expectancy. As an example, the highs and lows between the parameters between the second charger group G2 and the third charger group G3 are different, but assuming that the difference between parameters is within a set value, the charger group with higher charger usage rate, which is the first parameter, may be the group that requires more replacement or repair.

Accordingly, since the second charger group G2 may be classified as the middle grade level, and the third charger group G3 may be classified as the lower grade level, replacement or repair times may be scheduled or provided in the order of the third charger group G3, the second charger group G2, and the first charger group G1 in terms of charger life expectancy.

To sum up, the group setting part 200 may group according to parameters related to the lifespan of the charger 30 in order to equalize the charger usage rate. The initial charger groups and the initial group centroids may be moved by grouping, and the charger groups moved by grouping may be classified according to the charger life expectancy grade. The differential price setting part 310 may assign differential charging prices to the charger groups G classified according to the grouping grade levels determined by the group setting part 200, and the output limits setting part 330 may assign differential output limits to the charger groups G classified according to the grouping grade levels determined by the group setting part 200.

The first charger group G1 may belong to the upper grade level for vehicle guidance, the second charger group G2 may belong to the middle grade level for vehicle guidance, and the third charger group G3 may belong to the lower grade level for vehicle guidance. That is, it may be desirable for the differential price setting part 310 to set the differential charging prices low in the order of G1, G2, and G3 to guide vehicle charging in the order of G1, G2, and G3. In addition, it may be desirable for the output limit setting part 330 to set the charger output limits high in the order of G1, G2, and G3 to guide vehicle charging in the order of G1, G2, and G3.

Therefore, for the grouped charger groups G, priority for vehicle guidance may be determined according to parameters (charger usage rate or cumulative charging amount) that serve as a basis for classification, and the differential price setting part 310 may set the differential charging prices low according to the order of vehicle guidance priority, while the output limit setting part 330 may set the charger output limits high according to the order of vehicle guidance priority.

Referring to FIG. 7, initial charger groups 1100, 1200, and 1300 and initial group centroids 1120, 1220, and 1320 may be moved by grouping. Charger groups 1102, 1202, and 1302 moved by grouping may be classified according to the charger life expectancy grade. A system protection part 260 may provide scheduling for replacement or repair times for the charger groups G1, G2, and G3 according to the charger life expectancy grade.

In addition, in the above-described grouping method, the group setting part 200 may provide grouped results based on information such as charger usage rate and cumulative charging amount to the charger operator/manager, thereby indicating charger groups with a high risk of failure requiring replacement or repair among the chargers 30 being operated/managed. Thus, rather than the charger operator/manager randomly determining the replacement or repair time of the chargers 30, the replacement or repair time of the chargers 30 is scheduled on the basis of the grouping results of the group setting step S200, which helps to systematically manage the life of the chargers 30.

When using the grouping method described above in the step of group setting S200, the chargers 30 are not uniformly managed by grouping initially set based on initial parameter values, etc., but the group membership of each grouped charger 30 or charging station 20 changes depending on changes in the surroundings or situation, thereby improving the ability to respond to event occurrences.

For example, in FIG. 7, the initially set initial group centroids 1120, 1220, and 1320 are changed to the final group centroids 1122, 1222, and 1322 according to new grouping, indicating that the groups have also been moved accordingly. At this time, a given charger 1400 initially belongs to the first charger group G1 or 1100, but moves away from the first group 1102 moved by the new grouping and belongs to the new second charger group G2 or 1202 that has been moved. The given charger 1400 may correspond to the tenth charger 10* in FIG. 7. The tenth charger 10* in FIG. 7 initially belongs to the first charger group G1 to which the first charger and the ninth charger belong, but moves to the second charger group G2 to which the second, fourth, fifth, and sixth chargers belong by the grouping in the group setting step S200.

The method of the group setting S200 of the present disclosure as described above may be applied more effectively in an environment where power input and output rapidly changes in distributed loads including the electric vehicle 10 or the charger 30 (or charging station 20), where power input and output are concentrated at specific times, or where there is a lot of external influence.

What is claimed is:

1. A vehicle guidance device comprising at least one of:
a group setting part configured to group a plurality of charger populations on a basis of parameters including a charger usage rate or a cumulative charging amount;
a differential price setting part configured to assign differential charging prices to individual charger groups according to grouping information provided by the group setting part; and
an output limit setting configured to assign differential charger output limits to the individual charger groups according to the grouping information provided by the group setting part,
wherein priorities in guidance for electric vehicle charging are set according to charging price rankings determined by the differential price setting part or output limit rankings determined by the output limit setting part.

2. The device of claim 1, wherein the group setting part performs grouping according to parameters related to a charger lifespan in order to equalize a charger usage rate, and
the parameters include charger usage rates and cumulative charging amounts.

3. The device of claim 1, wherein the group setting part performs grouping according to parameters related to a charger lifespan in order to equalize a charger usage rate,
an initial charger group and an initial charger group centroid are moved by the grouping,
a charger group moved by the grouping is classified according to grades in terms of charger life expectancy,
the differential price setting part assigns the differential charging prices to charger groups classified according to grouping grade levels determined by the group setting part, and
the output limit setting part assigns the differential output limits to charger groups classified according to the grouping grade levels determined by the group setting part.

4. The device of claim 1, wherein the group setting part performs grouping according to parameters related to a charger lifespan in order to equalize a charger usage rate,
vehicle guidance priority is determined depending on which parameter is used as a criterion,
the differential price setting part sets a differential charging price low according to an order of the vehicle guidance priority, and
the output limit setting part sets a charger output limit high according to the order of the vehicle guidance priority.

5. The device of claim 1, wherein when a charging cable connected to a charger belonging to the charger populations is connected to an electric vehicle, an electric vehicle communication control module detects a PWM signal and starts communication by sending a signal to a charger communication control module of the charger, and
as the electric vehicle and the charger are electrically connected through the charging cable, the electric vehicle communication control module and the charger communication control module exchanges signals or information with each other.

6. The device of claim 1, further comprising:
a data collection part configured to collect parameter information for grouping the charger populations,
wherein the parameter information includes charger usage rates or cumulative charging amounts,
the information on the charger usage rates or the cumulative charging amounts is stored in a database provided in each charger or in a server each time charging is performed in the each charger, and
the parameter information is transmitted to the group setting part through the charger communication control module of the each charger or the server.

7. The device of claim 1, further comprising:
a display part configured to display or provide a target charger or charger group with vehicle guidance priority to help a user of an electric vehicle identify the target charger or charger group,
wherein differential information by price or output is identified step by step by means of the display part, and
the display part is implemented in software on an electric vehicle user's terminal or a charging kiosk in a way that includes an app or a web, or is implemented in hardware in each charger so as to be visually identified.

8. The device of claim 1, wherein the group setting part performs grouping according to parameters related to a charger lifespan in order to equalize a charger usage rate,
chargers are classified into a plurality of charger groups according to the parameters related to the charger lifespan,
wherein a number of the charger groups is determined by determining a distance between the charger groups on a basis of a sum of variance values of parameter values, and
on a basis of a degree to which each charger belonging to the charger groups deviates from a mean, or a square of the deviations across all chargers when calculating the distance between the charger groups.

9. The device of claim 1, wherein the group setting part performs grouping according to parameters related to a charger lifespan in order to equalize a charger usage rate,
an initial charger group and an initial charger group centroid are moved by the grouping, and
each charger belongs to one of a plurality of charger groups depending on a distance from the initial charger group centroid,
wherein the distance includes a Euclidean distance or a squared Euclidean distance, wherein the Euclidean distance is a Pythagorean distance between the each charger and the initial group centroid, based on a parameter value assigned to the each charger, and the squared Euclidean distance is a square of the Euclidean distance.

10. The device of claim 1, wherein the group setting part performs grouping according to parameters related to a charger lifespan in order to equalize a charger usage rate,
an initial charger group and an initial charger group centroid are moved by the grouping,
a charger group moved by the grouping is classified according to grades in terms of charger life expectancy, and
by the grouping, a group to which each charger belongs changes depending on changes in situations, including charging infrastructure around chargers.
